(19) United States
(12) Patent Application Publication
(10) Pub. No.: US 2024/0293860 A1
(43) Pub. Date: Sep. 5, 2024

(54) PRESSING DIE

(71) Applicant: G-TEKT CORPORATION, Saitama (JP)

(72) Inventors: Yoshihiro Takahashi, Gunma (JP); Soichiro Koyanagi, Shiga (JP)

(73) Assignee: G-TEKT CORPORATION, Saitama (JP)

(21) Appl. No.: 18/574,364

(22) PCT Filed: Jul. 15, 2022
(86) PCT No.: PCT/JP2022/027929

§ 371 Date: Dec. 27, 2023

(30) Foreign Application Priority Data
Jul. 16, 2021 (JP) 2021-118253

(51) Int. Cl. B21D 37/10

(52) U.S. Cl. CPC B21D 37/10

(57) ABSTRACT

An upper die having a reduced weight and sufficient rigidity. In a die which is used for a pressing machine including a lower die provided on a lower side in a height direction, an upper die provided on an upper side in the height direction, and a pressing mechanism that moves the upper die up and down, the die has a plurality of segments in which a concave portion partitioned by ribs is formed, on a rear surface side that is a side opposite to a processing surface.

### CROSS-REFERENCE TO RELATED APPLICATIONS

This application is the U.S. national stage application of International Application PCT/JP2022/027929, filed Jul. 15, 2022, which international application was published on Jan. 19, 2023, as International Publication WO 2023/286867 in the Japanese language. The International Application claims priority of Japanese Patent Application No. 2021-118253, filed Jul. 16, 2021. The international application and Japanese application are both incorporated herein by reference, in entirety.

### TECHNICAL FIELD

The present invention relates to a pressing die mounted in a pressing machine.

### BACKGROUND ART

Press molding of a metal plate material is the most common processing method widely used in production of automobiles, machines, electrical equipment, transportation equipment and the like because it ensures high productivity, excellent dimensional accuracy, little strength variation between products, and stable quality.

However, in particular, automobile parts are required to have high strength in view of weight reduction and the like, and therefore press-working tends to be difficult.

A press molding machine includes a fixed lower die, and an upper die that is moved up and down with respect to the lower die by a pressing machine.

The upper die is required to have high rigidity in view of press-workability, and therefore has been heretofore in the form of a solid block in its entirety with the inclusion of a processing surface and even a rear surface (for example, Patent Literature 1).

### CITATION LIST

### Patent Literature

Patent Literature 1: JP 2020-175447 A

### SUMMARY OF INVENTION

### Technical Problem

However, a solid upper die is heavy in terms of weight, and therefore a burden is placed on, for example, an up-and-down movement mechanism of a pressing machine, so that high-rate molding is difficult, thus causing impairment of productivity.

Accordingly, a main object of the present invention is to provide a die having a reduced weight and sufficient rigidity.

### Solution to Problem

A pressing die that solves the above-described problem has the following aspect.

A pressing die which is used for a pressing machine including a lower die provided on a lower side in a height direction, an upper die provided on an upper side in the height direction, and a pressing mechanism that moves the upper die up and down, wherein
the die includes a frame portion, a processing surface portion, and a rib crossing the processing surface portion, and
a plurality of segments each including a space surrounded by the rib, or a space surrounded by the rib and the frame portion are formed.

According to the aspect, a vertical-direction molding load applied to a processing surface can be supported by a plurality of segments each including a space surrounded by the rib, or a space surrounded by the rib and the frame portion, and an outward horizontal load acting on the die under a compressive load during molding can be supported by the frame portion.

Further, weight reduction can be achieved by the spaces of the formed segments.

In short, by a plurality of segments and the frame, a die can be provided which has sufficient rigidity while being light.

An aspect is proposed in which the segment includes a first rib extending in a first direction in plan view, and a plurality of second ribs crossing the first rib.

Since the first rib extends in the first direction while crossing a plurality of second ribs, rigidity against bending in the first direction is high.

Since the first rib is along a curved portion of the processing surface portion, that is, the direction in which the first rib extends coincides with the direction in which the curved portion of the processing surface portion extends, a heavy bending load acting during bending can be supported by the first rib.

When a third rib is formed in the other die so as to correspond to the first rib, a heavy bending load can be resisted by each of the ribs, so that it is possible to reliably perform bending.

When at least one of the segments has a honeycomb shape in plan view, it is possible to efficiently support a pressing load of the processing surface and a crushing load caused by horizontal and outward compression, and it is possible to increase a volume ratio of the space, so that not only the weight can be reduced, but also rigidity against the pressing load (longitudinal load) is enhanced.

When a bend portion on which distortion due to processing heavily acts is formed from a separate block different in material quality from the main body, and the block is a material having high strength, distortion can be sufficiently withstood, and when the block is made replaceable if necessary, convenience in maintenance is improved.

By increasing the curvature of an arcuate portion at a corner along a direction in which the frame portion and the processing surface portion are connected, outward collapse deformation of the frame portion which is caused by an outward horizontal load acting on the die under a compressive load during molding can be suitably suppressed.

On the other hand, when the curvature of an arcuate portion at a corner along a direction in which the rib and the processing surface portion are connected, where it is not necessary to place importance on collapse deformation, is relatively smaller than the curvature of the arcuate portion on the frame portion side, the volume of the space is accordingly increased to contribute to weight reduction.

When an intermediate rib is formed on the outer peripheral surface of the frame portion so as to extend along the periphery of the frame portion, outward opening deformation of the frame portion (in the case of the upper die, deformation in which the frame portion is curved downward and warped) which is caused by an outward horizontal load acting on the die under a compressive load during molding can be suitably suppressed in an extending direction of the intermediate rib.

Further, it is preferable that the intermediate rib in a height direction forms lateral concave portions on the upper and lower sides, respectively. The formation of the intermediate rib acts to increase the weight of the die, but the formation of lateral concave portions on the upper and lower sides, respectively, act to reduce the weight of the die, so that it is possible to enhance rigidity while suppressing an increase in weight of the die as a whole.

It is preferable that the intermediate rib extends around corner portions of the die and along the entire periphery including the front and back surfaces and the left and right surfaces of the frame portion. In this case, it is desirable that the lateral concave portion be formed on at least the front and back surfaces and the left and right surfaces of the frame portion excluding the corner portions. Since the corner portion of the die is a site that secures rigidity as a pillar against a pressing load, formation of the lateral concave portion resulting in reduction of the thickness of the frame portion should be inhibited where possible.

When at least one segment having a honeycomb shape is formed at the central portion of the die in plan view and a segment having a shape different from a honeycomb shape is formed at the peripheral portion of the die in plan view, it is possible to maximally exhibit an advantage associated with each shape.

### Advantageous Effects of Invention

According to the present invention, it is possible to provide a die having a reduced weight and sufficient rigidity.

### BRIEF DESCRIPTION OF DRAWINGS

FIG. 1 is a perspective view of an example of an upper die.

FIG. 2 is a view seen from the back side in a longitudinal direction.

FIG. 3 is a view taken along arrow 3-3.

FIG. 4 is a plan view of another die.

FIG. 5 is a plan view of another die.

FIG. 6 is a perspective view of still another example of a die.

FIG. 7 is a plan view of a different die.

FIG. 8 is a plan view of another different die.

FIG. 9 is a plan view of still another die.

FIG. 10 is a plan view of still another die.

FIG. 11 is a front view showing a part of an example of an outline of a pressing machine.

FIG. 12 is an explanatory diagram of the results of simulation evaluation.

FIG. 13 is a plan view of a first example of a combination shape.

FIG. 14 is a plan view of a second example of a combination shape.

FIG. 15 is a plan view of a third example of a combination shape.

FIG. 16 is a plan view of a fourth example of a combination shape.

FIG. 17 is a perspective view of an example of an upper die in a different aspect.

FIG. 18 is a perspective view of an example of an upper die having no intermediate rib.

FIG. 19 is a view taken along arrow 19-19.

FIG. 20 is a perspective view of an example of an upper die including an intermediate rib.

FIG. 21 is a view taken along arrow 21-21.

### DESCRIPTION OF EMBODIMENTS

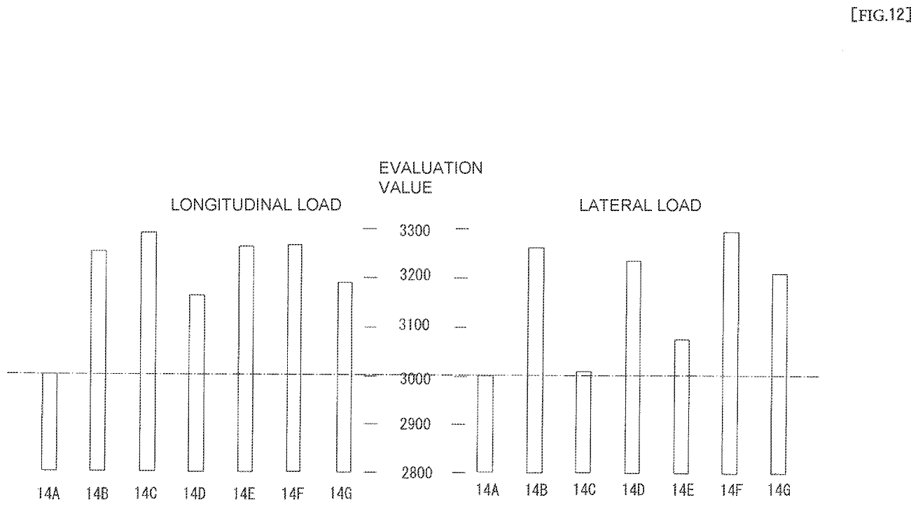

A pressing machine according to the present invention includes a lower die provided on a lower side in a height direction, an upper die provided on an upper side in the height direction, and a pressing mechanism that moves the upper die up and down. Examples of the pressing machine include a cold press molding apparatus 11 shown in FIG. 11. The pressing machine may be a hot press molding apparatus.

The press molding apparatus 11 is intended to mold a metal plate material 12, and includes a molding unit including a lower die 13 and an upper die 14.

For indicating a direction in illustration of a configuration of the press molding apparatus 11, the obverse side of the plane of paper is taken as the front side and the reverse side of the plane of paper is taken as the back side. When the press molding apparatus 11 shown in FIG. 11 is seen from the front side, the upper side is taken as the upper side of the press molding apparatus 11, and the left and the right are taken as the left and the right of the press molding apparatus 11.

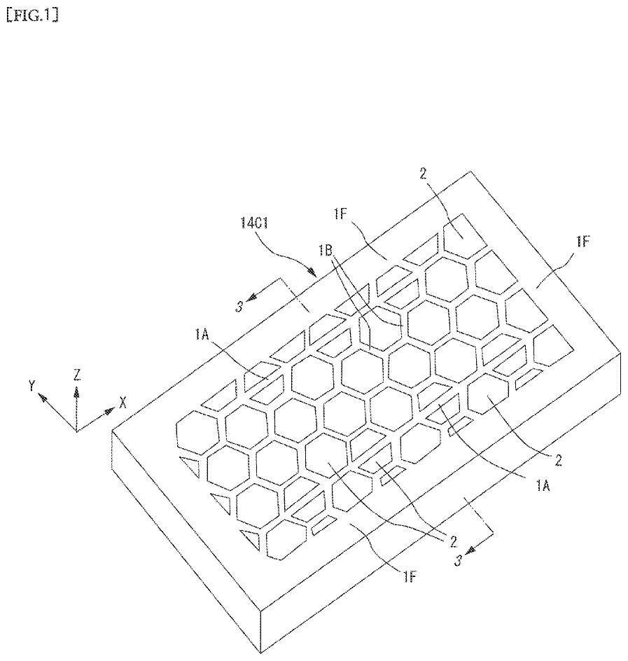

The same applies to the die, and referring to FIG. 1, the longitudinal direction, the crosswise direction and the height direction are also referred to as an X direction, a Y direction and a Z direction, respectively. When one of the X direction and the Y direction is referred to as a first direction, the other is a second direction.

The lower die 13 is mounted on a base (bolster) 24 of the molding unit with a lower die holder 23 interposed therebetween. A plurality of guide rods 25 extending in the vertical direction are provided upright on the base 24. The upper die 14 is mounted in an upper die holder (slide) 26. The upper die holder 26 is supported by the guide rod 25 while being able to move in the vertical direction. The upper die holder 26 is connected to a pressurization apparatus (not shown), and driven by the pressurization apparatus to move in the vertical direction. The upper die 14 mounted in the upper die holder 26 moves in the vertical direction between, for example, a molding position shown in FIG. 3 and a retraction position shown in FIG. 11 as the upper die holder 26 rises and falls. The pressing mechanism is configured as described above.

Examples in which the metal plate material 12 is molded include examples in which a metal plate for automobile bodies, in particular, a high-tensile-strength metal plate (for example, a high-tensile-strength steel plate) is molded.

As described above, the upper and lower dies are required to have high rigidity in view of press-workability, and therefore have been heretofore in the form of a solid block in its entirety with the inclusion of a processing surface and even a rear surface.

It is only required that one of the upper and lower dies have the configuration according to the present invention. In the following, the configuration of the embodiment will be described mainly for the upper die, and the lower die will also be described to the necessary extent.

In the following aspect, a die is used in which on a side opposite to a processing surface portion 1W including a processing surface, a concave portion (spaces) 2 partitioned by a frame portion 1F, a reinforcing rib 1A and a second rib 1B is formed, and a plurality of segments are present. In the lower die, a third rib 1C is formed (see FIG. 3).

In this way, it is possible to provide a die having a reduced weight and sufficient rigidity. Particularly for the upper die, the weight reduction leads to a decrease in burden on the up-and-down movement mechanism of the pressing machine, and the like, so that it is possible to perform molding at a high rate and with high accuracy.

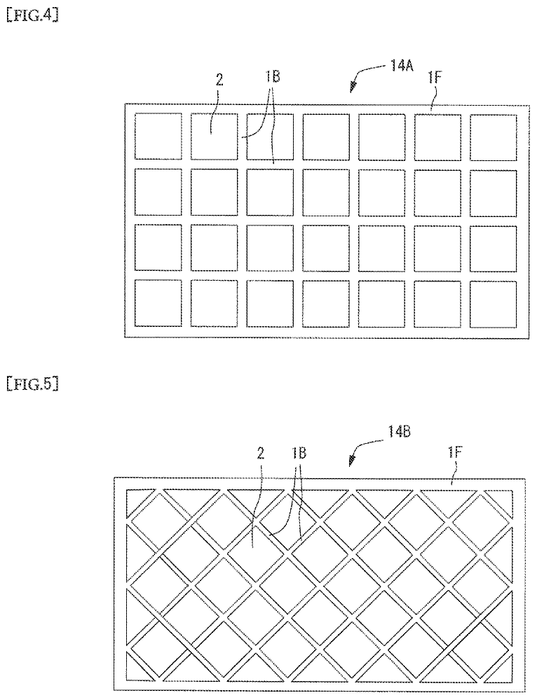

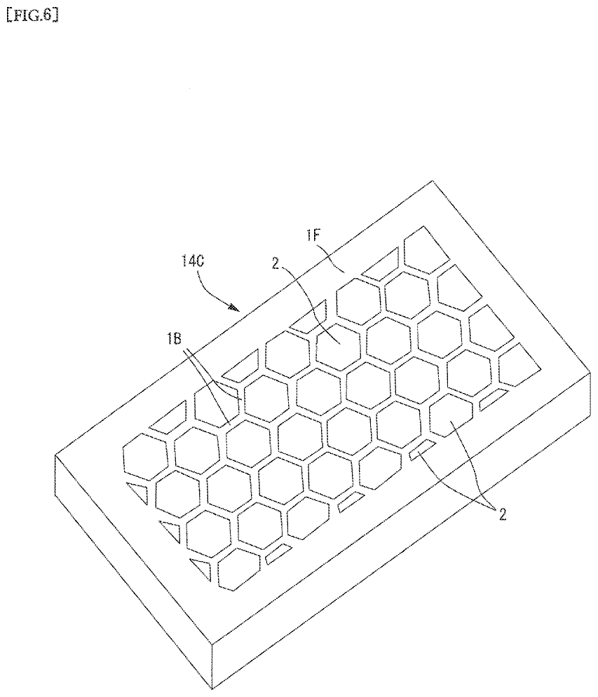

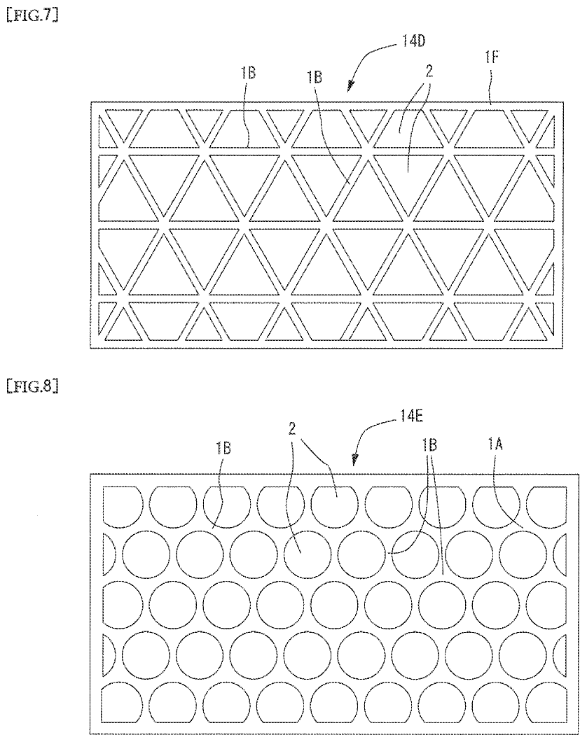

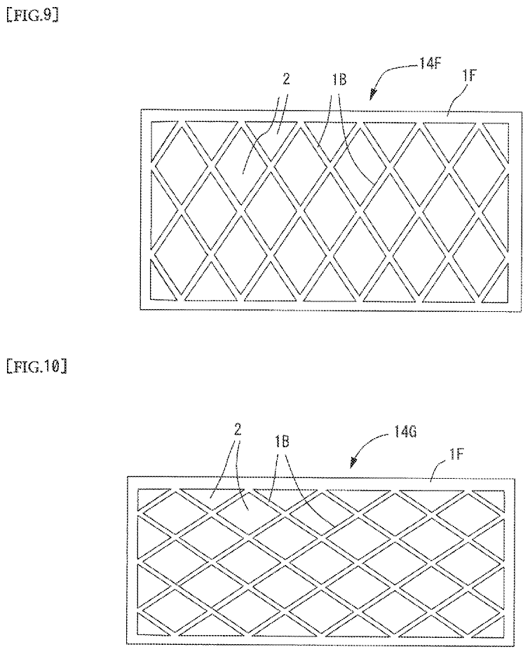

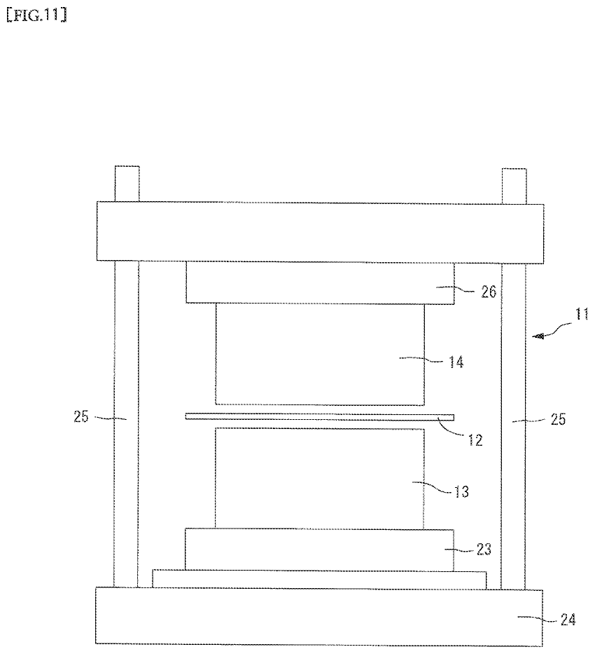

The (upper) die can be used in various forms. Examples thereof include the following:
(1) a square grid shape die 14A including a rib 1B having a square grid shape in plan view as shown in FIG. 4;
(2) a slanting grid shape die 14B including a rib 1B having a slanting grid shape in plan view as shown in FIG. 5;
(3) a honeycomb shape die 14C including a rib 1B having a honeycomb shape in perspective view as shown in FIG. 6;
(4) a truss shape die 14D including a rib 1B having a truss shape in plan view as shown in FIG. 7;
(5) a circle shape die 14E including a rib 1B having a concave portion having a circular shape in plan view as shown in FIG. 8;
(6) a longitudinally long slanting grid shape die 14F including a rib 1B having a longitudinally long (long in the longitudinal direction) slanting grid shape in plan view as shown in FIGS. 9; and
(7) a laterally long slanting grid shape die 14G including a rib 1B having a longitudinally long (long in the longitudinal direction) slanting grid shape in plan view as shown in FIG. 10.

For example, as shown in FIG. 1, the die includes a frame portion 1F, a processing surface portion 1W, and a rib crossing the processing surface portion 1W, in which a plurality of concave portions (spaces) 2 surrounded by the rib, or segments including a combination of the rib and frame portion 1F and the concave portion (space) 2 surrounded by the rib and the frame portion are formed.

The frame portion 1F, the processing surface portion 1W, and the processing surface portion 1W are continuously and integrally formed.

The rib separates the adjacent concave portions (spaces) 2, and the number of the segments formed is equal to the number of the concave portions (spaces) 2.

The segments take various forms. That is, in the form in FIGS. 1 and 3, some segments having a concave portion (space) 2 are formed by a reinforcing rib 1A continuously extending in a first direction (X direction in FIG. 1) in plan view, a plurality of second ribs 1B crossing the reinforcing rib 1A, and a frame portion 1F.

In addition, some segments having a concave portion (space) 2 are formed by the reinforcing rib 1A and a plurality of second ribs 1B.

Further, some segments having a concave portion (space) 2 are formed by a combination of a plurality of second ribs 1B, where the second ribs 1B do not cross the reinforcing rib 1A.

For example, as shown in FIG. 3, the reinforcing rib 1A extends in a first direction (X direction in FIG. 1). Here, the term “extend in a first direction (X direction in FIG. 1)” means linearly extending, as well as being aligned in the first direction (X direction in FIG. 1) as a whole while having a curved line shape, or a level difference.

For example, as shown in FIG. 6 for comparison, the reinforcing rib 1A is formed for further enhancing the rigidity on a partial basis (for reinforcing) for the honeycomb shape die 14C in which only second ribs 1B forms a honeycomb.

Note that the meaning of the reinforcing rib 1A is a rib that satisfies both the condition of “being along the first direction”, and the condition that “a rib is formed for reinforcing with respect to ribs forming a predetermined shape (for example, a honeycomb shape)” for further enhancing the rigidity on a partial basis.

Therefore, for example, in the example of the square grid shape die 14A shown in FIG. 4, the rib is not referred to as a reinforcing rib 1A because although the condition of “being along the first direction” is satisfied, the latter condition that “the rib is formed for reinforcing” is not satisfied.

A honeycomb shape die 14C1 as a representative example of the upper die is shown in FIGS. 1 to 3. The honeycomb shape die 14C1 has many segments on the rear surface side.

That is, segments having the concave portion (space) 2 are formed by the reinforcing rib 1A extending in the first direction (X direction in FIG. 1), a plurality of second ribs 1B crossing the reinforcing rib 1A, and a frame portion 1F.

In addition, there are segments in which the reinforcing rib 1A and a plurality of second ribs 1B form the concave portion (space) 2 without crossing the frame portion 1F.

Further, some segments having a concave portion (space) 2 are formed by a combination of a plurality of second ribs 1B, where the second ribs 1B do not cross the frame portion 1F and the reinforcing rib 1A.

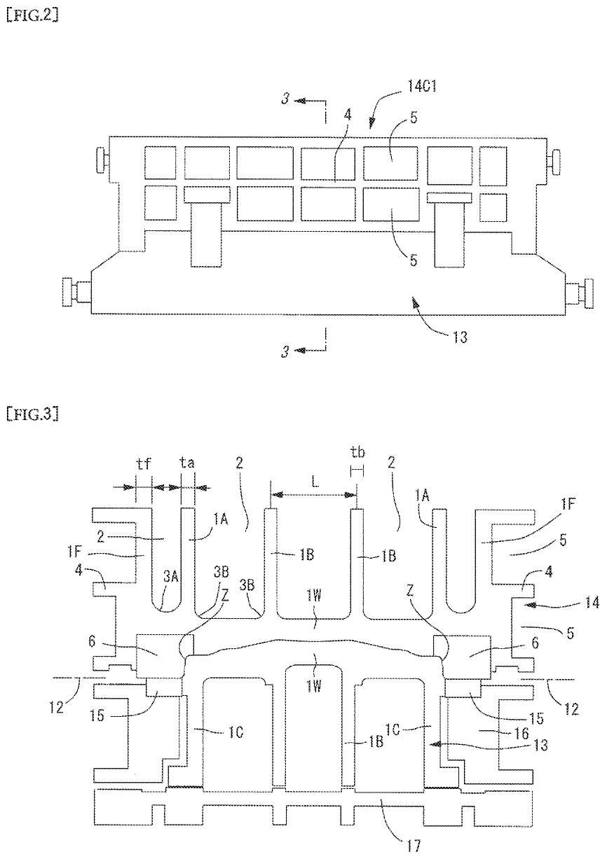

FIGS. 2 and 3 show an example of an aspect in which the automobile metal plate 12 (see FIG. 11) is subjected to bending/press molding with the upper die 14 and the lower die 13.

As shown in FIGS. 3, 20 and 21, the intermediate rib 4 is formed so as to extend around the corner portions 14X of the upper die 14 and along the entire periphery including the outer peripheral surface of the frame portion 1F of the upper die 14 and the frame portion 1F (front and back surfaces and left and right surfaces) (note that the intermediate rib 4 is not shown in FIG. 1).

According to this aspect, outward collapse deformation of the frame portion which is caused by an outward horizontal load acting on the die under a compressive load during molding can be suitably suppressed in an extending direction of the intermediate rib. In addition, rigidity can be secured by the formation of the intermediate rib 4, and weight reduction can be achieved by the formation of the lateral concave portion 5.

In the illustrated example, concave portions (spaces 2) are also formed in the lower die 15.

As shown in FIG. 3, on both side portions of the processing surface portion 1W of the upper die 14, high-strength upper mold die inserts (blocks) 6 different in material quality from the upper die 14 are provided.

On both side portions of the processing surface portion 1W of the lower die 13, blank holder inserts (blocks) 15 different in material quality from the lower die 13 are provided.

A bent portion (bend portion) Z is between a shoulder portion of the processing surface portion 1W of the lower die 13 and the upper mold die insert (block) 6.

The blank holder insert (block) 15 of the lower die 13 is held by the blank holder 16.

In the illustrated example, the lower side of the lower die 13 is closed by a lower die punch holder 17 connected by, for example, a bolt (not shown), but it is also possible to open the concave portion (space) 2.

Similarly, it is also possible to close the upper side of the upper die 14 by a upper die punch holder (not shown).

A great reaction force acts on the die during bending at the bent portion (bend portion) Z. Thus, the reinforcing rib 1A is formed along the first direction (X direction) at a position corresponding to the bent portion (bend portion) Z.

Further, a third rib 1C is formed in the lower die 13 so as to correspond to the reinforcing rib 1A.

The reinforcing rib 1A and the third rib 1C are not required to completely coincide in position in the horizontal direction with the bent portion (bend portion) Z, and may be deviated by up to about 50 mm in the horizontal direction.

On the other hand, turning to a bottom corner portion of the concave portion 2 with reference to FIG. 3, the corner along the first direction in which the frame portion 1F and the processing surface portion 1W are connected is an arcuate portion 3A having a center of curvature inside the concave portion 2, and the corner along the first direction in which the center side of the first rib 1A and the second rib 1B are connected to the processing surface portion 1W is an arcuate portion 3B having a center of curvature inside the concave portion 2.

If the bottom corner portion has an angle of, for example, 90 degrees, the portion may be damaged when a pressing load acts. On the other hand, when the bottom corner portion is an arcuate portion, there is an advantage that the load is dispersed, stress concentration does not occur, and damage can be prevented.

The arcuate portions 3A and 3B may have a circular-arc shape, or an arc shape in which portions having different curvature radii are connected and combined.

Here, it is desirable that the curvature of the arcuate portion 3A be larger than the curvature of the arcuate portion 3B. It is desirable that the curvature radius of each of the arcuate portions 3A and 3B be 20 to 70 mm.

It is desirable that the wall thickness of the frame portion 1F (tf) be 40 to 60 mm, and each of the wall thickness of the first rib 1A (ta) and the wall thickness of the second rib 1B (tb) be 20 to 40 mm. It is desirable that the rib interval L of the segment be 170 to 230 mm, particularly 180 to 220 mm.

The present inventors have examined mainly the rigidity of dies having a rib shape and a concave portion shape shown in dies 14A to 14G shown in FIGS. 4 to 10.

Simulation has been performed under conditions such that a set value with the Young's modulus being within the range of 100 to 170 Ga is selected, and the shape of the upper die is simply set to a rectangular parallelepiped.

The amount of deformation associated with the “longitudinal load” and “lateral load” has been calculated under conditions such that for the “longitudinal load”, the four corners of the bottom surface are confined in the X direction and the Y direction, and the bottom surface side is confined in the Z direction, and for the “lateral load”, both lateral surfaces (left and right lateral surfaces) in the Y direction are confined in the Y direction, and the bottom surface side is confined in the Z direction.

Further, the maximum amount of displacement and the average amount of displacement in deformation associated with the “longitudinal load” and the “lateral load” have been simulated by changing the area of one concave portion, i.e., the length between opposed sides, the diameter or the length between corners, as a segment length L as illustrated, while keeping substantially the same volume (area in plan view) of the simulation sample.

The results are shown in FIG. 12. The vertical axis represents an evaluation value. The larger the evaluation value, the higher the rigidity.

The following can be seen from the results of FIG. 12.
(1) The honeycomb shape type has the highest rigidity against the longitudinal load.
(2) The slanting grid shape type and the longitudinally long grid shape type also have high rigidity against the longitudinal load.
(3) The slanting grid shape type, the truss shape type and the longitudinally long grid shape type have high rigidity against the lateral load.
(4) On the other hand, the honeycomb shape type has remarkably high rigidity against the longitudinal load, but is equivalent to the grid shape types in rigidity against the lateral load.

The circular shape type has a similar tendency.
(5) Types with a shape in which ribs extend aslant, that is, the grid shape type, the truss shape type and the longitudinally long slanting grid shape type exhibits well-balanced rigidity for both the longitudinal load and the lateral load.
(6) The laterally long slanting grid shape type is not good in balance for both the longitudinal load and the lateral load.

As shown in the above results, a load direction in which rigidity necessary for the longitudinal load and the lateral load is required is selected according to e type of target metal material, a molding shape and the like, whereby a rib shape can be selected.

For example, if it is necessary to exhibit well-balanced rigidity for both the longitudinal load and the lateral load, a slanting grid shape type, a truss shape type, and a longitudinally long slanting grid type can be selected.

On the other hand, if importance is placed on the longitudinal load, in particular, a honeycomb shape type, or a circular shape type in some cases, can be selected.

On the other hand, in each of the above-described examples, the rib shapes are the same as a whole (except for the example of FIG. 1 in which the reinforcing rib 1A is formed).

However, for example, different rib shapes may be used in combination.

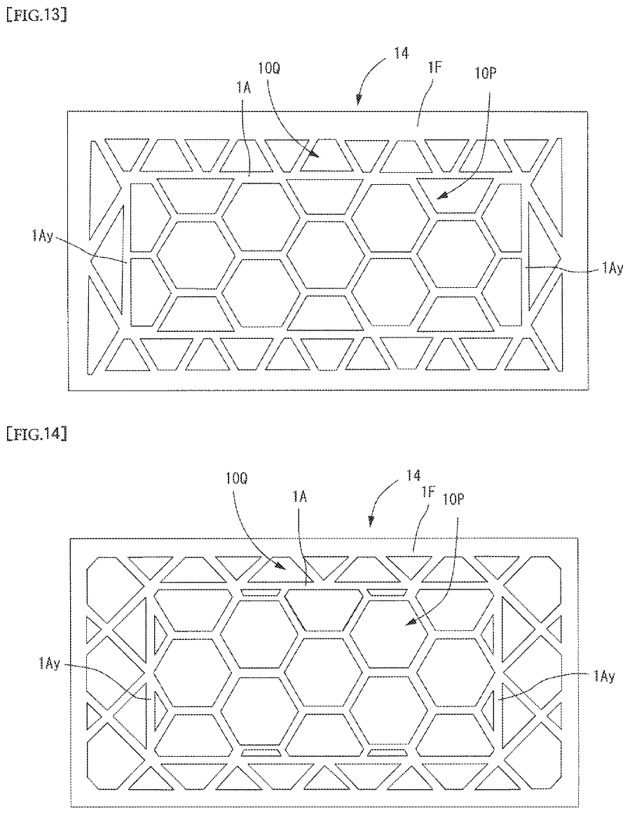

Mention may be made of, for example, examples shown in FIGS. 13 to 16. In the examples shown in FIGS. 13 to 16, a honeycomb-shaped rib 1-formed region 10P is formed at the center portion, and a region where a rib with another shape is formed 10Q is formed at the peripheral portion.

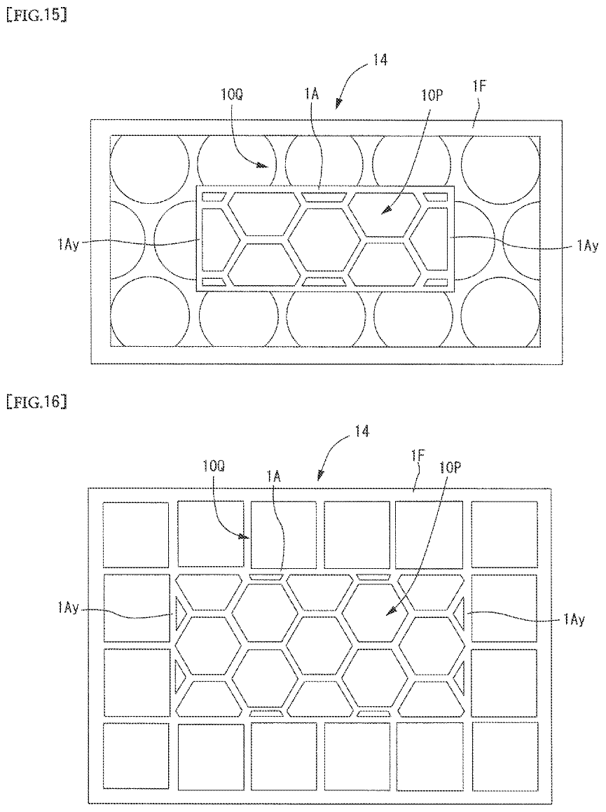

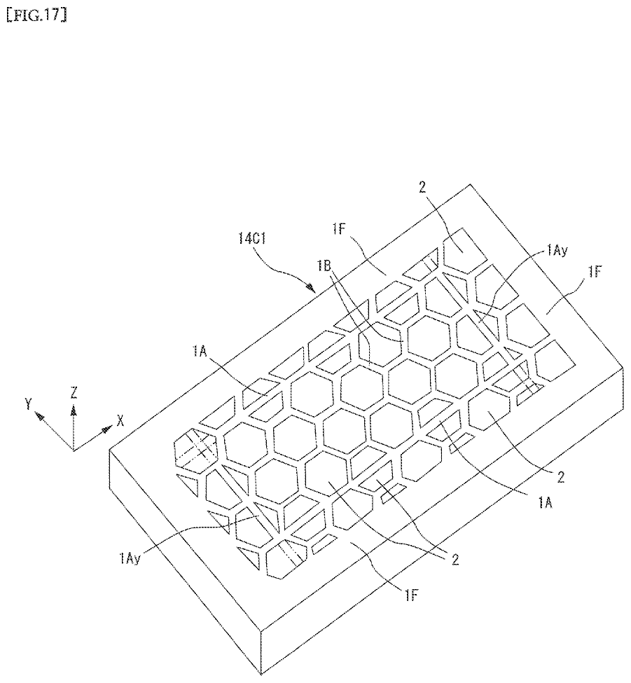

Specifically, the example of FIG. 13 is a first example in which the shape of the peripheral portion is a truss shape. The example of FIG. 14 is a second example in which the shape of the peripheral portion is a slanting grid shape. The example of FIG. 15 is a third example in which the shape of the peripheral portion is a circular shape. The example of FIG. 16 is a fourth example in which the shape of the peripheral portion is a square grid shape.

By using different rib shapes in combination, a die can be obtained which suitably adapts to the form of pressing of a target material while utilizing the advantage of each rib shape which is obtained in the simulation described above.

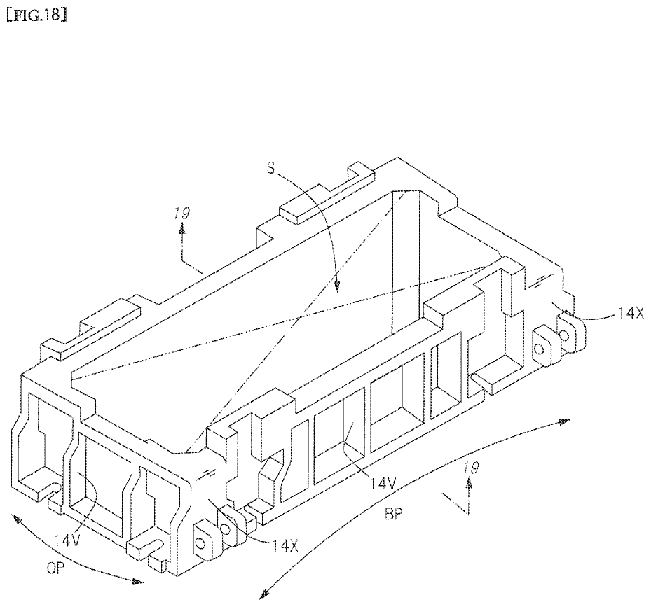

The first reinforcing rib 1A shown in FIG. 1 is formed along the first direction (X direction) for further enhancing rigidity on a partial basis, and for example, as in the form shown in FIG. 17, a first rib 1Ay similar to the first reinforcing rib 1A can also be formed in the second direction (Y direction) for further enhancing rigidity on a partial basis.

As indicated by virtual lines in FIG. 17, the first rib 1A and/or the first rib 1Ay may cross the frame portion 1F.

Further, the reinforcing rib 1A shown in FIG. 1 is along the longitudinal direction, but may be along the lateral direction.

On the other hand, turning to the honeycomb-shaped rib in the forms shown in FIGS. 13 to 16, it can be said that the illustrated reinforcing rib 1Ay is formed for further enhancing rigidity on a partial basis.

Next, advantages of forming the intermediate rib 4 will be described by showing some examples.

In the die, an outward horizontal load acting on the die under a compressive load during molding causes outer opening deformation of the frame portion. As shown in FIG. 18, the upper die tends to undergo deformation OP in which the frame portion is curved downward and warped on a lateral plane, and compressive deformation BP in which the frame portion is curved upward and warped on a longitudinal plane because the front and back ends are fixed.

When in accordance with the embodiment, the intermediate rib 4 is formed so as to extend along the periphery of the frame portion 1F and the corner portions 14X as shown in FIGS. 20, 21 and 3, occurrence of outward collapse deformation of the frame portion (in the case of the upper die, deformation in which the frame portion is curved downward and warped to open the frame portion) which is caused by an outward horizontal load acting on the die under a compressive load during molding can be suitably suppressed by formation of the intermediate rib.

Further, it is preferable that by formation of the intermediate rib 4 in a height direction, lateral concave portions 5, 5 are formed on the upper and lower sides, respectively. The formation of the intermediate rib 4 acts to increase the weight of the die, but the formation of lateral concave portions 5, 5 on the upper and lower sides, respectively, of the intermediate rib 4 act to reduce the weight of the die, so that it is possible to enhance rigidity while suppressing an increase in weight of the die as a whole.

It is preferable that the intermediate rib 4 extends around corner portions 14X of the die and along the entire periphery including the front and back surfaces and the left and right surfaces of the frame portion 1F. In this case, it is desirable that the lateral concave portions 5, 5 be formed on at least the front and back surfaces and the left and right surfaces of the frame portion 1F excluding the corner portions 14X. Since the corner portion of the die is a site that secures rigidity as a pillar against a pressing load, formation of the lateral concave portion resulting in reduction of the thickness of the frame portion should be inhibited where possible.

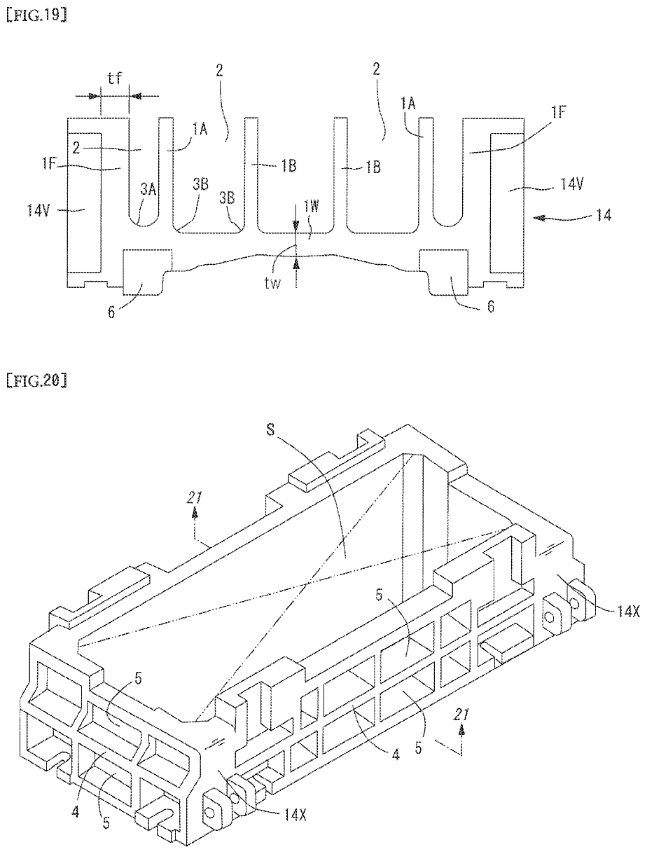

The present inventors have simulated various forms using a basic example in which only a longitudinal rib 14V is formed on a frame portion 14F as shown in FIG. 19. An upper surface S in FIG. 18 has segments configured as in FIG. 1, and is denoted by symbol S as an alternate.

The first example is an example in which the thickness tf of the frame portion 1F (tf) is changed from 40 mm to 50 mm.

The second example is an example in which the thickness of the processing surface portion (1w) is changed from 40 mm to 50 mm.

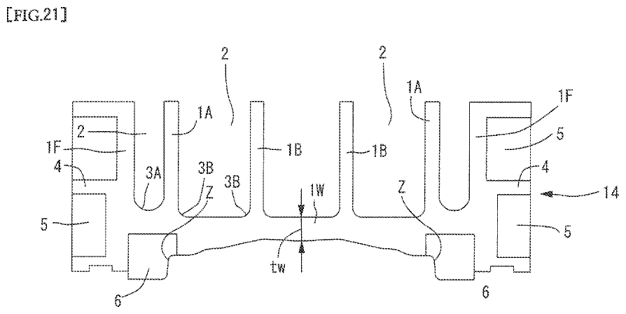

The third example is an example in which as shown in FIG. 20, the intermediate rib is formed so as to extend around corner portions 14X of the die and along the entire periphery including the front and back surfaces and the left and right surfaces of the frame portion 1F. The results obtained are as in Table 1.

TABLE 1

| | Ratio of | | |
|---|---|---|---|
| | increase | Warp | Compressive |
| | in weight | deformation | deformation |
| | of die | OP | BP |
| Basic example | — | Recognized | Recognized |
| First example | 2% | Recognized | Slightly recognized |
| Second example | 1% | Recognized | None |
| Third example | 8% | None | None |

These results show that by forming an intermediate rib, deformation OP and deformation BP of the die frame can be suppressed although the weight is slightly increased.

In FIG. 20, the height of the intermediate rib 4 is the same on the front and back surfaces and the right and left surfaces, but the present inventors have confirmed that the effect in Table 1 can be obtained as long as the height is in the range of ±50 mm with respect to the reference height.

### INDUSTRIAL APPLICABILITY

The present invention can be applied to a die in a press for cold processing, as well as a pressing machine for hot stamping 1.

### REFERENCE SIGNS LIST

1A, 1Ay Reinforcing rib
1B Second rib
1F Frame portion
1W Processing surface portion
2 Concave portion (space)
3A, 3B Arcuate portion
4 Intermediate rib
5 Concave portion
10P Honeycomb-shaped rib-formed region
10Q Region where a rib with another shape is formed
11 Press molding apparatus 11
12 Metal plate material
13 Lower die
14 Upper die
14A Square grid shape die
14B Slanting grid shape die
14C Honeycomb shape die
14D Truss shape die
14E Circular shape die
14F Longitudinally long slanting grid shape die
14G Laterally long slanting grid shape die
14C1 Honeycomb shape die
14X corner portion

1. A pressing die which is used for a pressing machine for a high-tensile metal plate for automobile bodies, comprising a lower die provided on a lower side in a height direction, an upper die provided on an upper side in the height direction, and a pressing mechanism that moves the upper die up and down,
wherein the die includes a frame portion, a processing surface portion, and a rib crossing the processing surface portion,
a plurality of segments each including a space surrounded by the rib, or a space surrounded by the rib and the frame portion are formed,
an intermediate rib is formed so as to extend along a periphery of front and back surfaces and left and right surfaces of the frame portion which form an outer peripheral surface of the frame portion,
the intermediate rib forms lateral concave portions on upper and lower sides, respectively, and
the frame portion, the processing surface portion and the rib are continuously and integrally formed.

2. The pressing die according to claim 1,
wherein the segment includes a first rib extending in a first direction in plan view, and a plurality of second ribs crossing the first rib, and
a first direction in which the first rib extends coincides with a ridgeline direction of a bend portion of the processing surface portion.

3. The pressing die according to claim 1,
wherein the segment includes a first rib extending in a first direction in plan view, and a plurality of second ribs crossing the first rib,
the first rib is along the bend portion of the processing surface portion, and
a curvature radius on the frame portion side where a corner along the first direction in which the frame portion and the processing surface portion are connected is an arcuate portion is larger than a curvature radius on the rib side where a corner along the first direction in which the rib and the processing surface portion are connected is an arcuate portion.

4. The pressing die according to claim 1, wherein the intermediate rib extends around corner portions of the die, and along the entire periphery including the front and back surfaces and the left and right surfaces of the frame portion, and on at least the front and back surfaces and the left and right surfaces of the frame portion except for the corner portions, the lateral concave portions are formed.

5. The pressing die according to claim 1, wherein at least one segment having a honeycomb shape is formed at a center portion of the die in plan view, and a segment having a shape different from a honeycomb shape is formed at the peripheral portion of the die in plan view.

6. The pressing die according to claim 1,
wherein the segment includes a first rib extending in a first direction in plan view, and a plurality of second ribs crossing the first rib,
the first rib is along the bend portion of the processing surface portion, and
a third rib is formed in the other die so as to correspond to the first rib.

7. The pressing die according to claim 1, wherein at least one of the segments has a honeycomb shape in plan view.

8. The pressing die according to claim 1,
wherein the segment includes a first rib extending in a first direction in plan view, and a plurality of second ribs crossing the first rib,
the first rib is along the bend portion of the processing surface portion, and
the bend portion is formed from a separate block different in material quality from a main body.

9. The pressing die according to claim 1,
wherein the segment includes a first rib extending in the first direction in plan view, and a plurality of second ribs crossing the first rib,
the segment further includes a reinforcing rib, and
the reinforcing rib is along the ridgeline of the bend portion of the processing surface portion in plan view, and is formed for reinforcing with respect to the first rib and the second ribs which form the segment.

10. The pressing die according to claim 9, wherein at least one of the segments formed by the first rib and the second ribs has a honeycomb shape in plan view.

11. A pressing upper die which is used for a pressing machine for a metal plate, the pressing machine comprising a lower die provided on a lower side in a height direction, the upper die provided on an upper side in the height direction, and a pressing mechanism that moves the upper die up and down,
wherein the upper die has a first direction and a second direction crossing the first direction in plan view, and includes integrally a surrounding frame portion, a processing surface portion, and a rib positioned in the frame portion crossing the processing surface portion,
a plurality of segments each including a space surrounded by the rib, or a space surrounded by the rib and the frame portion are formed,
the plurality of the segments are arranged adjacently to each other in the first direction, and arranged adjacently to each other in the second direction to form a regular shape in plan view,
a first rib different from said rib extends in the first direction and separate the plurality of segments arranged adjacently in the first direction from each other,
the first rib divides the regular shape of the plurality of segments arranged in the first direction adjacently to each other in the second direction,
the first rib extends along a curved portion of L shaped bending performed by the pressing machine, on the processing surface portion, and
the regular shape is a honeycomb shape.

12. The pressing upper die according to claim 1,
wherein the regular shape is a honeycomb shape, and the first rib divides the regular shape of the plurality of honeycomb shaped segments arranged in the first direction adjacently to each other in the second direction in plan view.

13. A pressing upper die which is used for a pressing machine for a metal plate, the pressing machine comprising a lower die provided on a lower side in a height direction, the upper die provided on an upper side in the height direction, and a pressing mechanism that moves the upper die up and down,
wherein the upper die has a first direction and a second direction crossing the first direction in plan view, and includes integrally a surrounding frame portion, a processing surface portion, and a rib positioned in the frame portion crossing the processing surface portion,
a plurality of segments each including a space surrounded by a rib, or a space surrounded by the rib and the frame portion are formed,
the plurality of the segments are arranged adjacently to each other in the first direction, and arranged adjacently to each other in the second direction to form a regular shape in plan view,
a first rib 1A different from said rib extends in the first direction and separate the plurality of segments arranged adjacently in the first direction from each other,
the first rib 1A divides the regular shape of the plurality of segments arranged in the first direction adjacently to each other in the second direction,
the first rib 1A extends along a curved portion (Z) of L shaped bending performed by the pressing machine, on the processing surface portion 1W,
the segment comprises the first rib 1A and a plurality of second ribs 1B crossing the first rib 1A,
a corner along the first direction in which the frame portion 1F and the processing surface portion 1W are connected, forms an arcuate portion 3A having a center of curvature inside a concave portion 2 surrounded by the first rib 1A and the frame portion IF,
a corner along the first direction on a central side of the die, in which the first rib 1A and the processing surface portion 1W are connected, forms an arcuate portion 3B having a center of curvature inside a concave portion 2 surrounded by the first rib 1A and the second rib 1B, and
a curvature radius of the arcuate portion 3A is larger than a curvature radius of the arcuate portion 3B.

14. The pressing die according to claim 2, wherein the intermediate rib extends around corner portions of the die, and along the entire periphery including the front and back surfaces and the left and right surfaces of the frame portion, and on at least the front and back surfaces and the left and right surfaces of the frame portion except for the corner portions, the lateral concave portions are formed.

15. The pressing die according to claim 3, wherein the intermediate rib extends around corner portions of the die, and along the entire periphery including the front and back surfaces and the left and right surfaces of the frame portion, and on at least the front and back surfaces and the left and right surfaces of the frame portion except for the corner portions, the lateral concave portions are formed.
